(19) United States
(12) Patent Application Publication
(10) Pub. No.: US 2025/0353067 A1
(43) Pub. Date: Nov. 20, 2025

(54) SLIDER ASSEMBLY

(71) Applicant: FIBRO GMBH, Hassmersheim (DE)

(72) Inventor: Markus MEYER, Wangen im Allgaeu (DE)

(21) Appl. No.: 18/872,861

(22) PCT Filed: Jan. 19, 2023
(86) PCT No.: PCT/EP2023/051219

§ 371 Date: Dec. 9, 2024

(30) Foreign Application Priority Data
Jul. 12, 2022 (DE) 10 2022 117 325.9

(51) Int. Cl. B21D 37/12; B21D 37/04

(52) U.S. Cl. CPC B21D 37/12; B21D 37/04

(57) ABSTRACT

A slider tool has a slider bed and a slider movably mounted thereon by means of gliding plates (G1, G2) on a dovetail guide, wherein an unsymmetrical concept of the dovetail connection is provided.

The invention relates to an improved slider assembly, in particular a quill slider and a wedge driver slider. The invention in particular relates to a quill slider for fastening in a tool made of several parts, in particular in a slider unit with an upper part and a hold-down device, wherein the quill slider comprises at least one quill.

Sheet metal parts for the automotive industry are becoming increasingly complex and therefore the construction of tools often reaches the limit of what is possible. The produced parts should be finished at the end of the molding and punching operation, if possible. Thus, several functions of the active parts in different angle positions must be coordinated and matched to one another in the tool. An increasing part of such functions is taken over by modern sliders with drivers which are installed above or below.

The invention can also be applied to a wedge driver with a slider element receipt, a movable slider element and a driver element, wherein gliding surfaces are provided between the slider element and the driver element and a guiding means with gliding surfaces on the slider element and gliding surfaces on the slider element receipt is provided between the slider element and the slider element receipt.

A wedge driver also referred to as a slider generally serves to deflect pressure forces in punching or forming tools in order to be able to thereby machine in particular oblique or back partial areas of body parts. Typically, the slider element receipt is connected to a part of the pressing tool in which the wedge driver is to perform the punching or forming work. A wedge driver is referred to as an upper part slider if its slider element receipt is fastened in the upper part of the pressing tool which is connected to the moving pressing plunger. The term lower part slider is used if its slider element receipt is connected to the lower pressing tool fastened on the rigid pressing table. Regardless of the part the slider element receipt of the wedge driver is connected to, the slider element receipt usually has a linear guide in which the movable slider element can be moved back and forth, but as such is firmly connected to the slider element receipt. The driver element is usually firmly connected to the part of the pressing tool as a rigid element on which the slider element receipt is not fastened. The driver element usually has tapered wedges and with them serves as a drive element with regard to the movable slider element. But there are also limits to the use of wedge sliders, especially if no driver can be placed in the tool due to lack of space.

Here, quill sliders have been used so far in some cases. Quill sliders are known in the most different applications and designs. A quill serves to receive and move a machining tool, e.g. a punching tool, wherein there is a movement in the longitudinal direction, i.e. axially. This movement is caused by a quill driver. In order to avoid an unintended deflection of the quill, it usually runs in a quill receipt. The quill driver and the quill receipt are usually permanently fitted in the tool or part of it.

Quill sliders are known from publication WO 2007/006161 A1, for example. Herein, a means is disclosed, wherein the movable mold part contains sliders and ejectors and quill sliders which are arranged in an angle to one another and a support plate for supporting the quill sliders which are supported on a support surface which is received perpendicularly by a support plate and is arranged to the quill sliders. Sliders and quill sliders are actuated by two-way hydraulic cylinders.

DE 101 53 721 C5 discloses a tool for cylinder crank cases which is made of at least two tool parts. The tool has several sliders for demolding cavities and bores. The tool comprises cylinder-shaped quills for creating the cylinder bores. The quills can be part of a slider, i.e. in the shape of quill sliders. The quills run through the tool from a wall on the side of the cylinder head to a wall on the side of the crank shaft.

From DE 10 2006 016 078 A1, another quill slider is known. DE 231 408 A1 reveals an additional device for all-purpose tool milling machines for slicing molds, stamps and electrodes for spark erosion. The additional device consists of a cast housing in which the work carriage with pivoting means for receiving tools in a prism guide moves up and down. Alternatively, it has a long cylindrical bore in which a quill in the shape of a piston rod executes the stroke movements and the rotatable tool receipt is provided on the lower quill end. In order to avoid the quill from coming into an axial rotational movement, a groove is incorporated over the full length (coaxially), and it is guided by a wedge fixed in the housing. In this device, an actuation cylinder which fastens the piston rod in the quill is provided on the upper lid. Below, a bearing point for receiving the shaft protrudes.

In the state of the art, the focus is on the further development of a slider element so that a guide for the movable slider element is created which enables an even better running precision which optimally translates the acting pressing force into the punching or forming movement which compensates side boosts and is to cause a uniform force distribution.

In the state of the art, solutions are known where the movable slider element has a kind of a dovetail connection, wherein the slider element receipt is formed as a corresponding counterpart so that the side of the slider element formed as a dovetail can engage the corresponding slider element receipt and can itself be guided and held therein in a centering manner. In doing so, great value is placed on the symmetrical arrangement. The surfaces on the slider element and the slider element receipt each provided by the dovetail shape are symmetrically supported on each other, wherein due to the surfaces being in an angle to one another the dovetail shape can receive forces directed in different directions.

In particular, the state of the art specifically teaches a particular symmetrical arrangement as it has a symmetrical force distribution and other characteristics and advantages concerning smooth running. For this, gliding plates are proposed on two sides of the slider element or the slider element receipt, wherein these are arranged symmetrically in order to reach the goals mentioned above. So, for example, EP 2 197 660 B1 offers a solution which has proven to be disadvantageous in particular with regard to installation security.

This symmetric dovetail solution is provided with gliding surfaces for bearing gliding plates and formed to engage a corresponding receipt on the slider bed formed as a dovetail so that the gliding plates are arranged symmetrically and in an L-shape. Thus, with a symmetric dovetail on the slider and a respective correspondingly symmetrically shaped receipt on the slider bed and the slider body, the gliding plates positioned in between are also in an arrangement which is symmetrical thereto.

“Symmetrical” in the sense of the present invention is defined accordingly analogously. The geometries and surfaces relevant for and involved in the cooperation of the slider with its contour on the corresponding receipt on the slider bed are considered.

However, there are high requirements on a correct and accurate installation due to unsymmetrical installation situations and the high accuracy requirements in the complex tools and the unavoidable manufacturing tolerances. Often, the tools are used as intended in an installation situation which is not symmetrical so that a reversed or wrong installation can have drastic consequences. However, in the solution known in the state of the art, an installation twisted by 180° with regard to the target situation is possible, so that in operation there can be great (in some cases immediate) damage on the tool and the parts to be machined.

This problem can occur in particular in case of a symmetrical dovetail guide as an installation twisted by 180° of a generally symmetrically arranged guide and gliding bearing can lead to the mentioned problems. If, for example, a hole punch attached on the slider is off-center, there may be a crash in the tool if it is twisted by 180°.

It is therefore an object of the present invention to overcome the mentioned disadvantages and to provide a slider which enables good running characteristics and a desired force distribution on the one hand, but on the other hand improves installation security and avoids an incorrect installation.

This object is achieved by the combination of features according to claim 1.

A basic idea of the invention is, as opposed to the state of the art, no symmetrical, but an unsymmetrical arrangement of a dovetail connection, in particular with regard to the operative connection between the slider and the slider bed. Specifically in this definition with regard to the tool center (for the wedge driver tool) or the slider center (for the quill slider), an unsymmetrical arrangement of a dovetail connection is to be realized so that an arrangement of the dovetail connection and the gliding bearing plates possibly arranged thereon which in total is not symmetrical is obtained.

For this, the following measures with regard to the dovetail connection between the slider and the corresponding slider bed are proposed:
A symmetry plane through the holding section formed as a dovetail is formed offset to the symmetry axis through the tool center or the shape of the dovetail on the slider or its outer contour is in itself created unsymmetrically (e.g. one side is enlarged or shaped differently compared to the opposite side and compared to a symmetric dovetail shape).
One of the two bearing surfaces formed for the gliding plates on the dovetail of the slider is lower or higher than the diametrically opposite other bearing surface with regard to a position as seen in the height direction. As a result, therefore, the gliding plates are arranged offset in other relative positions in the height direction as well.
The two bearing surfaces on the dovetail for bearing the gliding plates mentioned above can also be formed in another angle of attack.

In this connection, it is noted that the features mentioned above, which lead to an unsymmetrical arrangement or shape, exclusively refer to those features which make a contribution to the connection of the dovetail and in particular represent the outer contour for the bearing of the gliding plates and the dimensions relevant for symmetry.

Particularly preferred is a solution in which the deviation of the two planes (tool plane and symmetry plane of the dovetail connection) are close to one another, but offset next to one another in order to realize the advantages of good guiding characteristics and optimum force distribution on the one hand and a clear mounting position of the slider on the slider bed on the other hand.

For this, the invention proposes a slider tool having a slider bed and a slider movably mounted thereon by means of gliding plates on a dovetail guide, the slider having a slider body and a slider holder formed thereon, wherein a first symmetry plane S1 of the slider body and/or of the slider bed is present which runs through the center of the slider and/or the slider tool, wherein the slider has a holding section formed as a dovetail to a second symmetry plane S2, and the first symmetry plane S1 does not coincide with the second symmetry plane S2 so that gliding plates provided on gliding surfaces of the holding section formed as a dovetail are arranged unsymmetrically to the first symmetry plane.

Thus, according to a concept of the invention, the arrangement of the gliding plates and thus the position of the holding section shaped as a dovetail is not placed in the tool center and thus not in the symmetry plane of the slider tool or the slider bed, but laterally or transversely offset thereto. Thus, the gliding plates can remain embodied as identical parts, but the holding section shaped as a dovetail is formed off-center on the slider. This excludes an accidental assembly twisted by 180°.

In a further design of the invention, it is provided that the slider is mounted on a driver on a side of the slider opposite the dovetail guide. Thus, the invention can be realized with a traditional wedge driver consisting of a slider bed, a slider and a driver.

It is of further advantage if the slider (in particular when realized as a quill slider) is mounted axially movable in at least one guide bush along a central center slider axis X. Advantageously, two guide bushes provided axially in series one after the other are provided.

In a further design according to the invention, it is provided that the gliding plates are formed in an L-shape and that their legs forming the L-shape protrude in a respective recess on the slider bed. Particularly advantageously, the gliding plates on the slider are arranged under an angle with regard to the two symmetry planes. In this way, the gliding surfaces also run obliquely to the symmetry planes.

It is further advantageously realized that a groove for a holding means protruding from the holding section formed as a dovetail and engaging the groove or the guide groove is provided on the slider bed. According to a concept of the invention, the guide groove is positioned in the center and symmetrically to the tool center with regard to the lateral tool edges, while the holding means is offset on the dovetail with regard to the symmetry plane of the dovetail protrusion, in particular transversely offset to the symmetry plane.

For this reason as well, mounting the slider on the slider bed can only be realized in the position as intended. If the slider was twisted by 180°, there would be a collision during assembly due to the geometric conditions between the position of the holding means and the guide groove. This also prevents an incorrect assembly.

Further, it is preferred that the center and in particular the central slider axis X runs within the second symmetry plane S2.

Symmetry planes are understood to be those planes in the sense of the present invention where the respective position of the relevant parts of the slider tool is symmetrical to this plane. Looking at the guide groove of the slider bed, for example, its shape and position is symmetrical to the first symmetry plane of the slider bed, for example, even if the slider bed does not have a perfect symmetry in all details. Instead of the symmetry plane, this can correspondingly alternatively also be the part center in a concept according to the invention.

In this case, according to the invention, the center of the holding section formed as a dovetail and the tool center or the slider center fall apart.

Thus, it is particularly preferred if the second symmetry plane S2 is offset by a distance y obliquely to the slider axis X or slider center with regard to the first symmetry plane S1, wherein this is only a comparably small deviation here (e.g. 1-5% of the tool width).

In a further design of the invention, it is provided that on a tool-side end of the guide groove, a detachable blocking means is provided which prevents the complete disassembly of the slider along the dovetail guide as long as the blocking means is in its blocking position.

Further preferred features are:
the slider has a round, rectangular or polygonal cross section;
the at least one guide bush has a round, rectangular or polygonal cross section;

Other advantageous refinements of the invention are characterized in the subclaims and/or depicted in greater detail below together with the description of the preferred embodiment of the invention with reference to the figures.

### BRIEF DESCRIPTION OF THE DRAWINGS

FIG. 1 shows an example perspective representation of a slider tool (quill slider);

FIG. 2 shows a lateral view of the embodiment according to FIG. 1;

FIG. 3 shows an alternative example embodiment of the invention (wedge driver tool);

FIG. 4 shows a lateral view of the embodiment according to FIG. 3;

FIG. 5 shows a first sectional view through the example embodiment according to FIG. 1;

FIG. 6 shows a front view of the example embodiment according to FIG. 1, and

FIG. 7 shows a further sectional view through the example embodiment according to FIG. 1,

FIG. 8 shows a detail of FIG. 7, and

FIG. 9 shows an alternative example embodiment of an unsymmetrical dovetail connection.

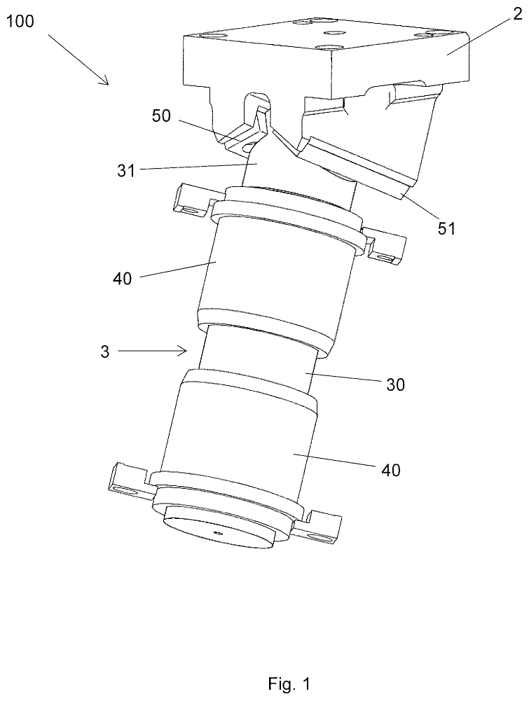

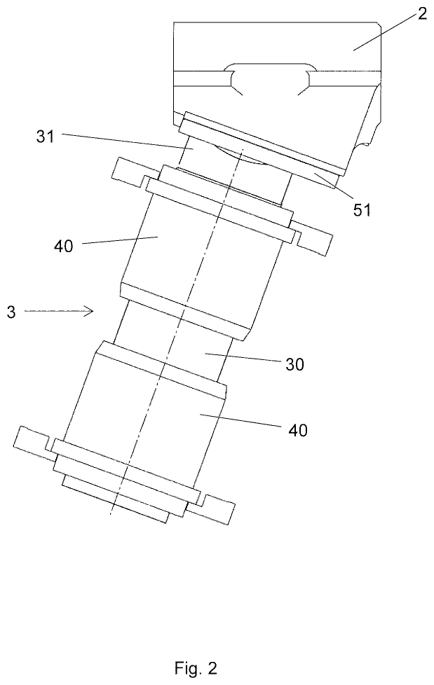

Hereinafter, the invention will be explained in greater detail with reference to FIGS. 1 to 9, wherein same reference symbols refer to same structural and/or functional features.

In FIG. 1, an example representation of a slider tool 100 is formed as a quill slider. The slider tool 100 possesses a slider bed 2 and a slider 3 movably mounted thereon by means of gliding plates 50, 51 on a dovetail guide.

The slider 3 possesses a slider body 30 (on the end-side end of which a machining tool is attachable) and a slider holder 31 formed thereon for mounting the slider 3 on the slider bed 2.

The slider body 30 possesses a center axis X and a first symmetry plane S1 which coincides with the symmetry plane of the slider bed 2 and thus characterizes a common symmetry plane and thus the center of the slider tool.

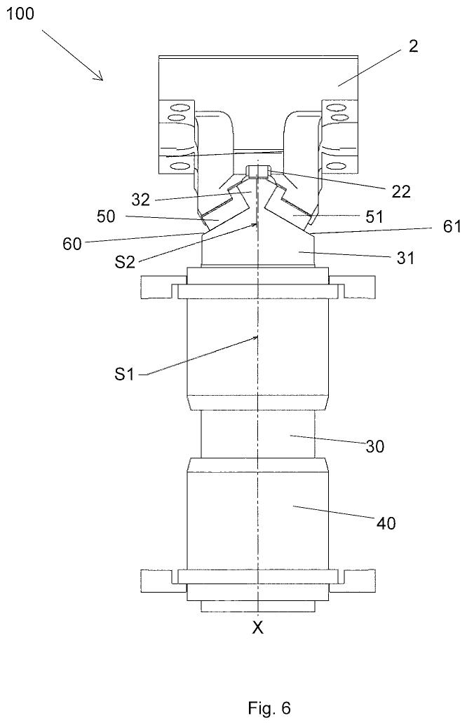

The slider holder 31, on the other hand, forms a holding section 32 formed as a dovetail which is formed symmetrically to a second symmetry plane S2. However, the first symmetry plane S1 and the second symmetry plane S2 do not coincide, but lie next to one another offset by the distance y (as is clearly recognizable in FIGS. 6 to 8), so that the gliding plates 50, 51, which are provided on the gliding surfaces of the holding section 32 formed as a dovetail, are arranged unsymmetrically to the first symmetry axis S1 as intended. In case of a twisted assembly, the slider then cannot be brought together with the driver (in case of a wedge slider) anymore or guided in the guide bushes 40 (in case of a quill slider 100) as these have to be offset to one another by said distance y.

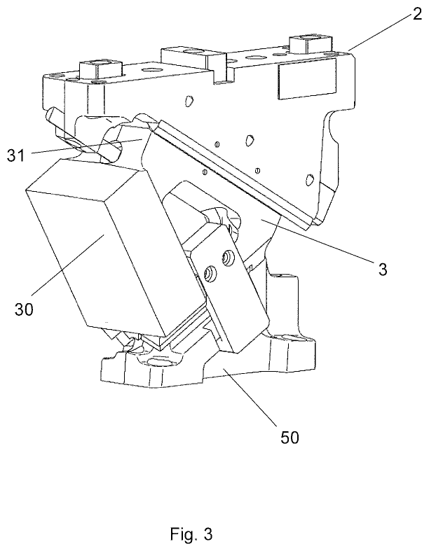

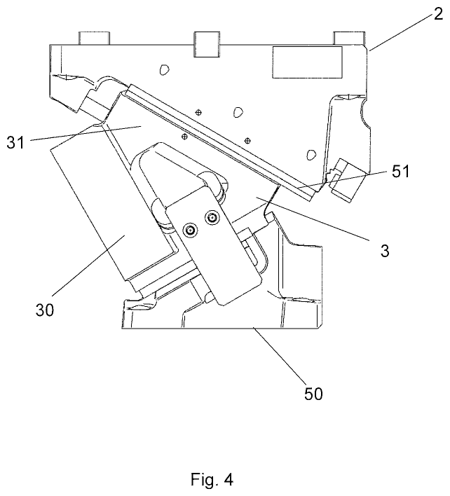

In the embodiment according to FIG. 3 and FIG. 4, in which a wedge driver tool 100 is shown, the slider 3 is mounted on a driver 60 on a side of the slider 2 opposite the dovetail guide.

With the quill slider 100, it is recognizable that the slider 3 is mounted axially movable in two guide bushes 40 along a central center slider axis X and the guide bushes annularly enclose the slider.

In both embodiments, the gliding plates 50, 51 are formed in an L-shape and a (short) leg 50a, 51a forming the L-shape protrudes into a respective indentation (recess) on the slider bed 2.

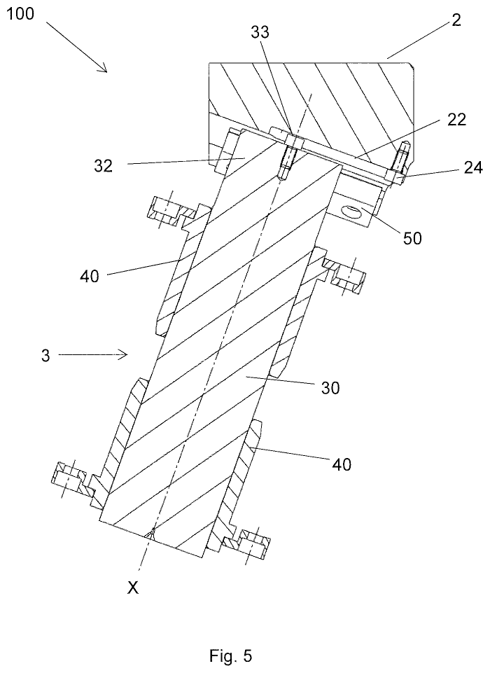

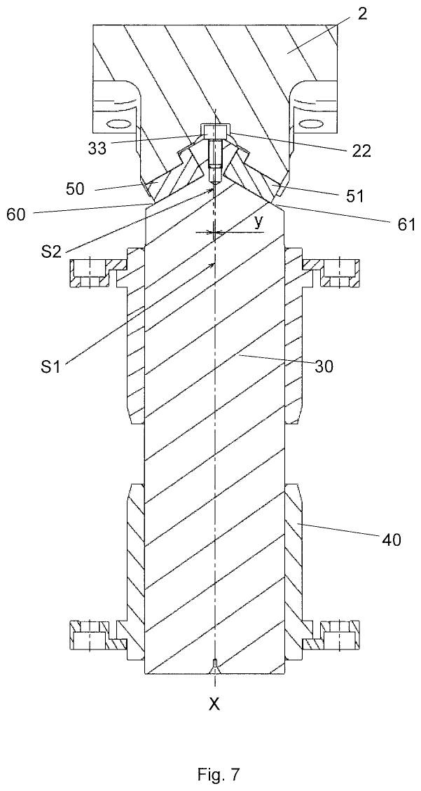

In FIGS. 5 and 7, it is clearly recognizable that a center guide groove 22 for a holding means 33 protruding from the holding section 32 formed as a dovetail and engaging the guide groove 22 is provided in the slider bed 2. The holding means 33 can be a screw with a screw head.

In FIGS. 6 and 7, on the other hand, it is clearly recognizable that the center and in particular the central slider axis X runs within the first symmetry plane S1 and the second symmetry plane S2 is offset by a distance y obliquely to the slider axis X or slider center with regard to the first symmetry plane S1.

In FIG. 5, it is further recognizable that on a tool-side end of the guide groove 22, a detachable blocking means 24 is provided which prevents the complete disassembly of the slider 3 (from its mounting position to a removal position) along the dovetail guide as long as the blocking means 24 is in its blocking position (represented in FIG. 5).

In this example embodiment, the slider 3 and the guide bushes 40 of the quill slider possess a circular cross section so that the circle center also determines the center of the slider 3 and the position of the symmetry plane S2.

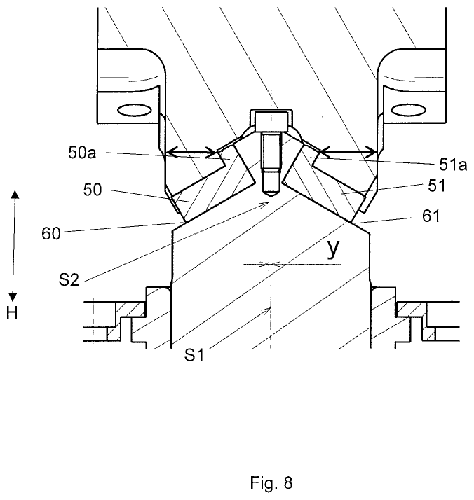

FIG. 8 shows a detail of FIG. 7 to illustrate how the symmetry plane S2 of the dovetail guide and the position of the gliding plates 50, 51 lies offset from the symmetry plane S1 of the slider bed and the slider body by the distance y.

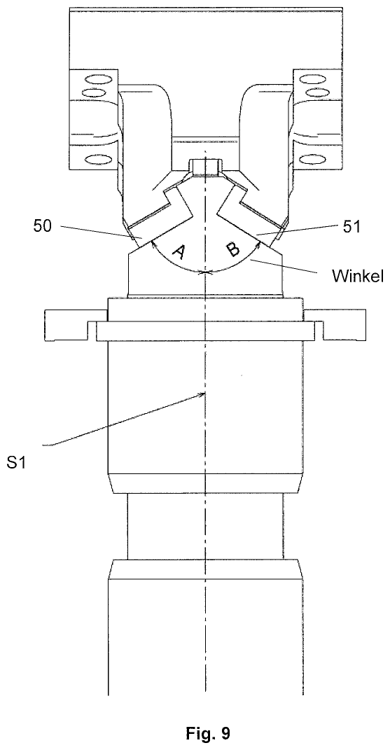

FIG. 9 shows an alternative example embodiment of an unsymmetrical dovetail connection in which the angles A and B are different, whereby the bearing surfaces 60, 61 for the gliding plates 50, 51 possess different angles of attack.

FIG. 8 suggests a further possible embodiment with the height direction H in which the bearing surfaces 60, 61 for the gliding plates 50, 51 can possess the same angles of attack, but are offset in the height direction H in their relative position to one another. From this, a respective unsymmetrical solution can also be obtained.

According to the invention, the shown solutions are advantageous in that the two gliding plates 50, 51 are formed as identical parts despite the unsymmetrical geometry of the dovetail and no different components are required.

The invention is not limited in its execution to the abovementioned preferred exemplary embodiments. Rather, a number of variants are conceivable which make use of the illustrated solution even in the form of fundamentally different embodiments.

1. A slider tool, having a slider bed and a slider movably mounted thereon by means of gliding plates on a dovetail guide, the slider having a slider body and a slider holder formed thereon, wherein a first symmetry plane (S1) of the slider body and/or of the slider bed is present which runs through the center of the slider and/or the slider tool, wherein the slider holder has a holding section formed as a dovetail and symmetrically to a second symmetry plane (S2), and the first symmetry plane (S1) does not coincide with the second symmetry plane (S2) so that gliding plates are provided on gliding surfaces of the holding section formed as a dovetail which gliding plates are arranged unsymmetrically to the first symmetry plane (S1).

2. A slider tool, having a slider bed and a slider movably mounted thereon by means of gliding plates on a dovetail guide, the slider having a slider body and a slider holder formed thereon which has an unsymmetrically shaped holding section formed as a dovetail which holding section engages a correspondingly shaped receiving section on the slider bed.

3. The slider tool according to claim 1, characterized in that the slider is mounted on a driver on a side of the slider opposite the dovetail guide.

4. The slider tool according to claim 1, characterized in that the slider is mounted axially movable in at least one guide bush along a central center slider axis (X).

5. The slider tool according to claim 1, characterized in that the gliding plates are formed in an L-shape and that their legs forming the L-shape protrude in a respective recess on the slider bed.

6. The slider tool according to claim 1, characterized in that a guide groove for a holding means protruding from the holding section formed as a dovetail and engaging the guide groove is provided on the slider bed.

7. The slider tool according to claim 1, characterized in that the center and in particular the central slider axis (X) runs within the first symmetry plane (S1).

8. The slider tool according to claim 1, characterized in that the second symmetry plane (S2) is offset by a distance y obliquely to the slider axis (X) or slider center with regard to the first symmetry plane (S1).

9. The slider tool according to claim 1, characterized in that on a tool-side end of the guide groove, a detachable blocking means is provided which prevents the complete disassembly of the slider along the dovetail guide as long as the blocking means is in its blocking position.

10. The slider tool according to claim 1, characterized in that the slider has a round, rectangular or polygonal cross section.

11. The slider tool according to claim 1, characterized in that the at least one guide bush has a round, rectangular or polygonal cross section.

12. The slider tool according to claim 1, characterized in that an assembly of the slider twisted by 180° with regard to an assembly as intended is prevented due to the unsymmetrical design.

13. The slider tool according to claim 1, characterized in that the gliding plates on the slider are arranged under a respectively different angle with regard to the slider axis X.
